(19) United States
(12) Patent Application Publication
(10) Pub. No.: US 2010/0318902 A1
(43) Pub. Date: Dec. 16, 2010

(54) PROCESSING APPARATUS AND METHOD THAT GENERATE SUITABLE DISPLAY INFORMATION, AND STORAGE MEDIUM

(75) Inventor: Toru Yoshida, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/795,452

(22) Filed: Jun. 7, 2010

(30) Foreign Application Priority Data
Jun. 11, 2009 (JP) 2009-140020

(51) Int. Cl. G06F 17/00; G06F 17/24

(52) U.S. Cl. 715/249; 715/273

(57) ABSTRACT

A processing apparatus that can produce a suitable display according to a user's operation purpose, thus improving operability for a user. A purpose of a user's operation is determined, and processing capacity information on the processing apparatus, which suits the determined purpose, is obtained. Based on the obtained processing capacity information, a type of document information to be displayed is determined. The display information is generated in accordance with document information corresponding to the determined type.

### BACKGROUND OF THE INVENTION

1. Field of the Invention

The present invention relates to a processing apparatus and a method that generate suitable display information in response to a user's request for document information, as well as a non-transitory computer-readable storage medium storing a program.

2. Description of the Related Art

In recent years, as technologies for computerization of sheet documents have improved, and general-purpose file formats for electronic documents have become widespread, various equipment such as digital multifunctional peripherals and printers have become capable of handling a plurality of types of electronic documents. For example, they have a function of scanning in a sheet document, converting the same into document data in PDF or the like, and storing the document data in a server or the like, and a function of directly printing document data in JPEG format, PDF format, or the like without using an application and a printer driver.

Conventionally, to make the above functions easy to use, various methods have been proposed. For example, to make document data easy to locate, there has been proposed a technique to change an order in which document data is displayed using an operation history (see, for example, Japanese Laid-Open Patent Publication (Kokai) No. 2006-080748). As computerization of sheet documents increasingly becomes widespread, the amount of document data stored in equipment increases.

On the other hand, an operation screen on an image forming apparatus is generally small and uneasy to comprehend at a glance, and it may be thus difficult for a user to find desired document data. To address this problem, there has been proposed a technique to preferentially display document data which is likely to be used.

Also, to facilitate configuration of a process for conversion into document data, there has been proposed a method in which an operation menu is constructed according to capacity information on a printer and capacity information on an own apparatus (see, for example, Japanese Laid-Open Patent Publication (Kokai) No. 2007-088887). This is a technique to improve usability for a user by constructing an operation menu using only items on which operation can be performed among a plurality of setting items.

However, the above conventional techniques are mainly to improve usability concerning a process in which a sheet document is converted into document data and stored, a process in which document data is directly printed, and so on, and no mention is made of how to improve operability for equipment having a plurality of functions.

In a case where there is a difference between a file format which a sheet document can be scanned in by a scanner and converted into document data and a file format that enables direct printing, if document data in both formats is displayed in the same manner when viewed, this is not user-friendly. For example, when a user is operating for the purpose of printing, if document data that cannot be printed is displayed, the problem that the document data is printed by mistake, or the problem that it is difficult for the user to find document data which he/she intends to actually print may arise.

Moreover, when a user is operating for the purpose of storage, if document data in a format that cannot be converted is displayed, this may mislead the user. Also, the user may miss what exists as document data in a format which may cause overlapping of document data names. For example, according to the technique described in Japanese Laid-Open Patent Publication (Kokai) No. 2006-080748, because it aims to improve operability in carrying out a process in which a sheet document is converted into document data and stored, and a process in which document data is directly printed, there may be a case where even document data that cannot be printed is displayed.

### SUMMARY OF THE INVENTION

The present invention provides a processing apparatus and a method that can produce a suitable display according to a user's operation purpose, thus improving operability for a user, as well as a non-transitory computer-readable storage medium storing a program.

Accordingly, in a first aspect of the present invention, there is provided a processing apparatus that generates display information in response to a processing request from a user for document information, comprising a first determination unit adapted to determine a purpose of the user's operation, an obtaining unit adapted to obtain processing capacity information on the processing apparatus, which suits the determined purpose, a second determination unit adapted to, based on the obtained processing capacity information, determine a type of document information to be displayed, and a generation unit adapted to generate the display information in accordance with document information corresponding to the type determined by the second determination unit.

Accordingly, in a second aspect of the present invention, there is provided a processing apparatus that is connected to an information processing apparatus via a network, and carries out a storage process in response to a request for document information from the information processing apparatus, comprising a determination unit adapted to determine a port number of a port having received the request, an obtaining unit adapted to obtain display information in response to the request for document information according to the determined port number, and a sending unit adapted to send the obtained display information to the information processing apparatus as a request source.

Accordingly, in a third aspect of the present invention, there is provided a processing method for a processing apparatus that generates display information in response to a processing request from a user for document information, comprising a first determination step of determining a purpose of the user's operation, an obtaining step of obtaining processing capacity information on the processing apparatus, which suits the determined purpose, a second determination step of, based on the obtained processing capacity information, determining a type of document information to be displayed, and a generation step of generating the display information in accordance with document information corresponding to the type determined in the second determination step.

Accordingly, in a fourth aspect of the present invention, there is provided a processing method for a processing apparatus that is connected to an information processing apparatus via a network, and carries out a storage process in response to a request for document information from the information processing apparatus, comprising a determination step of determining a port number of a port having received the request, an obtaining step of obtaining display information in response to the request for document information according to the determined port number, and a sending step of sending the obtained display information to the information processing apparatus as a request source.

Accordingly, in a fifth aspect of the present invention, there is provided a non-transitory storage medium storing a computer-readable program for causing a computer to execute a processing method.

Accordingly, in a sixth aspect of the present invention, there is provided a non-transitory storage medium storing a computer-readable program for causing a computer to execute a processing method.

According to the present invention, a suitable display can be produced according to a user's operation purpose so that operability for a user can be improved.

Further features of the present invention will become apparent from the following description of exemplary embodiments (with reference to the attached drawings).

### BRIEF DESCRIPTION OF THE DRAWINGS

FIG. 1 is a diagram schematically showing an exemplary arrangement of a system including an image forming apparatus which is an example of embodiments to which the present invention is applied.

FIG. 2 is a block diagram schematically showing an arrangement of an essential part of a digital multifunctional peripheral appearing in FIG. 1.

FIG. 3 is a block diagram showing functions required for displaying, storage, conversion, printing, and so on of document data in the digital multifunctional peripheral.

FIG. 4 is a flowchart showing a process carried out by a digital multifunctional peripheral according to a first embodiment when displaying of a document data list is requested.

FIGS. 5A and 5B are views showing exemplary screens displayed on a console of the digital multifunctional peripheral, in which FIG. 5A shows an exemplary main menu screen, and FIG. 5B shows an exemplary storage location selection screen.

FIGS. 6A and 6B are views showing exemplary document list screens displayed on the console of the digital multifunctional peripheral.

FIGS. 7A and 7B are views showing exemplary screens displayed on the console of the digital multifunctional peripheral, in which FIG. 7A shows an exemplary storage location selection screen, and FIG. 7B shows an exemplary document list screen.

FIGS. 8A and 8B are views showing exemplary document list screens displayed on the console of the digital multifunctional peripheral.

FIGS. 9A and 9B are views showing exemplary screens displayed on the console of the digital multifunctional peripheral, in which FIG. 9A shows an exemplary print setting screen, and FIG. 9B shows an exemplary original reading screen.

FIG. 10 is a flowchart showing a process carried out by a digital multifunctional peripheral according to a second embodiment when a document data list displaying request is received.

FIG. 11 is a view showing an exemplary screen displayed on an administrator-use page on the Web displayed in the computer.

FIG. 12 is a diagram showing an exemplary screen in a folder on the Web displayed in the computer.

FIG. 13 is a diagram showing an exemplary screen in a folder on a network displayed in the computer.

FIG. 14 is a flowchart of a process carried out by a digital multifunctional peripheral according to a third embodiment when storage of document data is requested.

### DESCRIPTION OF THE EMBODIMENTS

The present invention will now be described in detail with reference to the drawings showing embodiments thereof.

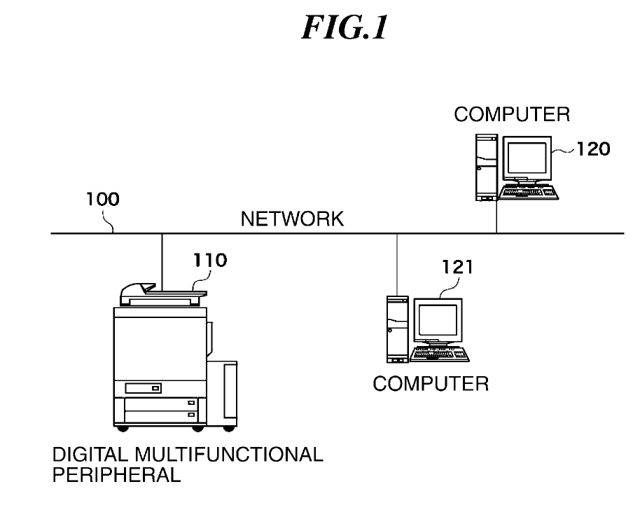

FIG. 1 is a diagram schematically showing an exemplary arrangement of a system including an image forming apparatus which is an example of embodiments to which the present invention is applied.

A digital multifunctional peripheral 110 is an image forming apparatus having a function of converting a scanned-in sheet document into document data (document information), and a function of printing the document data. Computers 120 and 121 are information processing apparatuses such as so-called personal computers. These apparatuses are connected together via a network 100 such as a LAN (local area network). It should be noted that a printing apparatus, an image processing apparatus, and so on, not shown, may be connected to the network 100.

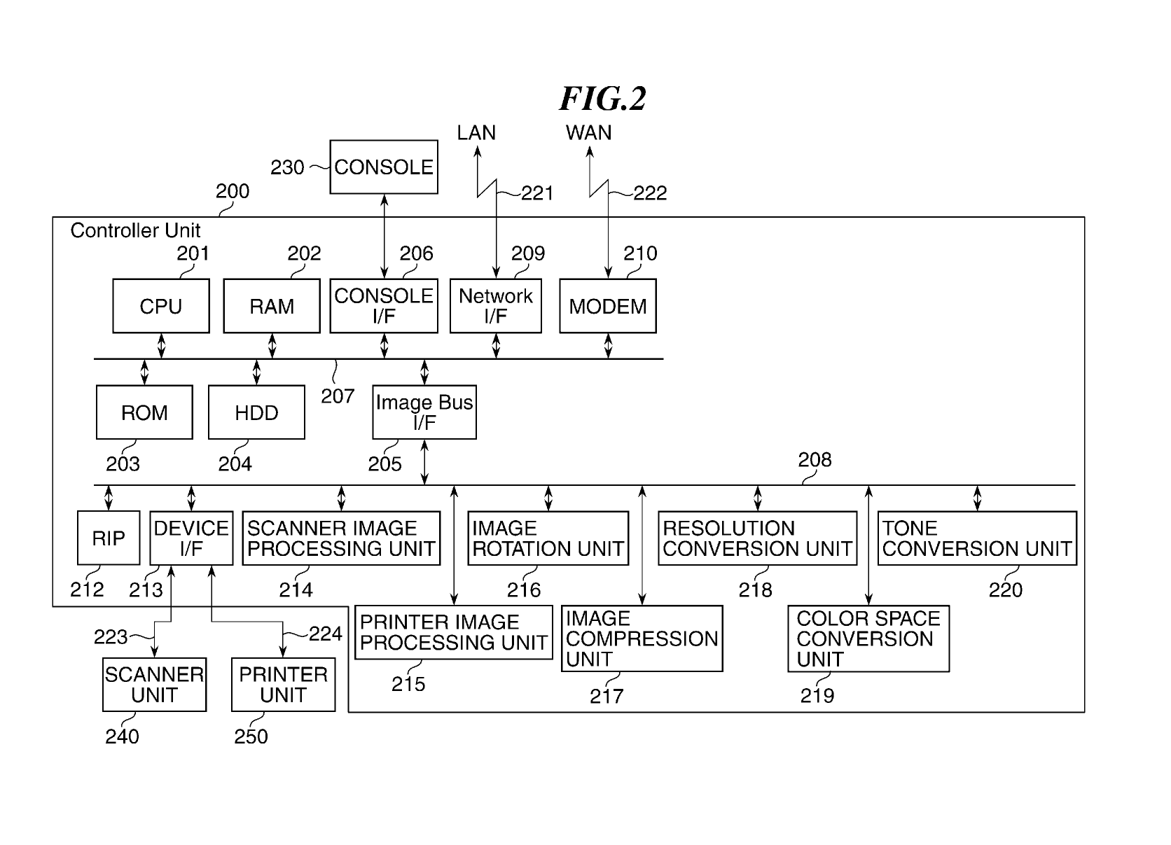

FIG. 2 is a block diagram schematically showing an arrangement of an essential part of the digital multifunctional peripheral 110 appearing in FIG. 1.

The digital multifunctional peripheral 110 has a controller unit 200, a console 230, a scanner unit 240 that is an image input device, and a printer unit 250 that is an image output device. The controller 200 has the scanner unit 240 and the printer unit 250 connected thereto, and also has the console 230 connected thereto.

The controller unit 200 provides control to realize a copy function of printing out image data, which is scanned in by the scanner unit 240, using the printer unit 250. Also, the controller unit 200 provides control to input and output image information and device information by connecting to a LAN 221 or a public line (WAN) 222.

The controller unit 200 has a CPU 201. The CPU 201 boots an operation system (OS) by a boot program stored in a ROM 203, and executes, on the OS, application programs stored in a hard disk drive (HDD) 204. As a result, various types of processing are executed. The CPU 201 uses a RAM 202 as a work area. The RAM 202 provides the work area as well as an image memory area for temporarily storing image data. The HDD 204 stores the above described application programs and image data.

The ROM 203 and the RAM 202 are connected to the CPU 201 via a system bus 207. Further, a console I/F (console interface) 206, a network I/F 209, a modem 210, and an image bus I/F (image bus interface) 205 are connected to the CPU 201.

The console I/F 206 is an interface for connecting with the console 230 having a touch panel, and outputs, to the console 230, image data to be displayed on the console 230. Also, the console I/F 206 sends out, to the CPU 201, information input by a user on the console 230.

The network I/F 209 is connected to the LAN 221, and inputs and outputs information to and from each apparatus on the LAN 221 via the LAN 221. The modem 210 is connected to the public line 222, and inputs and outputs information via the public line 222.

The image bus I/F 205 is a bus bridge that connects to each other the system bus 207 and an image bus 208 transferring image data at high speed, and converting data format. The image bus 208 is comprised of a PCI bus or an IEEE 1394. To the image bus 208 are connected a raster image processor (RIP) 212, a device I/F 213, a scanner image processing unit 214, a printer image processing unit 215, and an image rotation unit 216. Further, to the image bus 208 are connected an image compression unit 217, a resolution conversion unit 218, a color space conversion unit 219, and a tone conversion unit 220.

The RIP 212 is a processor that expands a PDL code into a bitmap image. To the device I/F 213 are connected the scanner unit 240 and the printer unit 250. The device I/F 213 carries out synchronous-to-asynchronous conversion of image data. The scanner image processing unit 214 corrects, processes, and edits input image data. Also, the scanner image processing unit 214 has a function of determining whether an input image is of a color original or a black-and-white original based on a signal indicative of a saturation of the image, and holding the determination result. The printer image processing unit 215 carries out correction, resolution conversion, etc. on printout image data according to the performance of the printer unit 250.

The image rotation unit 216 can collaborate with the scanner image processing unit 214 to rotate an image at the same time when the image is scanned in by the scanner unit 240, and store the image on memory. Further, the image rotation unit 216 can rotate an image and store the same on the memory, or print out an image present on the memory while rotating the same in collaboration with the printer image processing unit 215.

The image compression unit 217 applies JPEG compression and decompression processing to multi-valued image, and compression and decompression processing of JBIG, MMR, MH, or the like to binary image data. The resolution conversion unit 218 applies a resolution conversion process to an image on the memory and stores the processed image on the memory. The color space conversion unit 219 converts a YUV image present on the memory into a Lab image through matrix computation, and stores the Lab image on the memory. The tone conversion unit 220 converts, for example, an 8-bit image with 256 levels of gray present on the memory into a 1-bit image with 2 levels of gray using an error diffusion technique or the like, and stores the image on the memory.

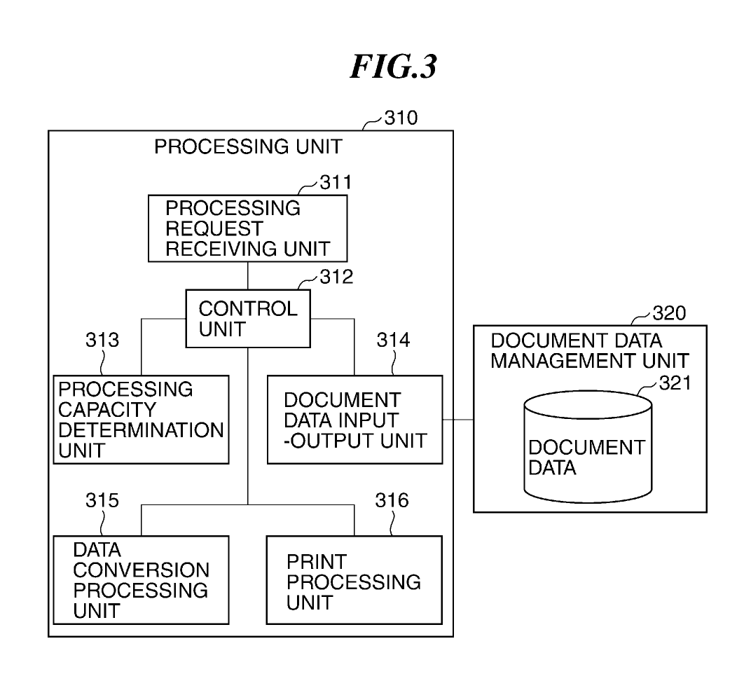

FIG. 3 is a block diagram showing functions required for displaying, storage, conversion, printing, and so on of document data in the digital multifunctional peripheral 110. The functions shown in FIG. 3 are comprised of software modules and the like, and they are usually stored in the HDD 204, loaded into the RAM 202, and executed by the CPU 201.

In the digital multifunctional peripheral 110, a processing unit 310 and a document data management unit 320 collaborate with each other to carry out a control process in displaying, storage, conversion, printing, or the like of document data. The processing unit 310 is comprised of a processing request receiving unit 311, a control unit 312, a processing capacity determination unit 313, a document data input-output unit 314, a data conversion processing unit 315, and a print processing unit 316. The document data management unit 320 includes document data 321.

When the CPU 201 receives a request (instruction) from the user from the console 230 via the console I/F 206, the processing request receiving unit 311 analyzes the request, and the control unit 312 determines processing contents complying with the request and carries out an appropriate process. To carry out the appropriate process, the control unit 312 issues a processing request to each of the processing capacity determination unit 313, the document data input-output unit 314, the data conversion processing unit 315, and the print processing unit 316 according to the processing contents.

The processing capacity determination unit 313 obtains processing capacity information and setting information on the digital multifunctional peripheral 110 to determine a processing capacity of the digital multifunctional peripheral 110 at the time of receipt of the processing request. The document data input-output unit 314 reads out document data from the document data management unit 320 and stores document data in document data management unit 320. Also, the document data input-output unit 314 generates list information on document data stored in the document data management unit 320. The data conversion processing unit 315 carries out a process to convert a sheet document scanned in by the scanner unit 240 into document data. The print processing unit 316 carries out a process to print document data by the printer unit 250.

In a first embodiment of the present invention, a description will be given of a process carried out when a request to display document data stored in a document data storage region called a box in the digital multifunctional peripheral 110 is received from the console 230 of the digital multifunctional peripheral 110. The box is comprised of a plurality of directories having a hierarchical structure, and has document data stored and managed therein.

The processing capacity of the digital multifunctional peripheral 110 assumes that formats of printable document data are TIFF (Tag Image File Format) and JPEG (Joint Photographic Experts Group). Further, the processing capacity of the digital multifunctional peripheral 110 assumes that formats into which image data scanned in by the scanner unit 240 can be converted are TIFF and PDF (Portable Document Format).

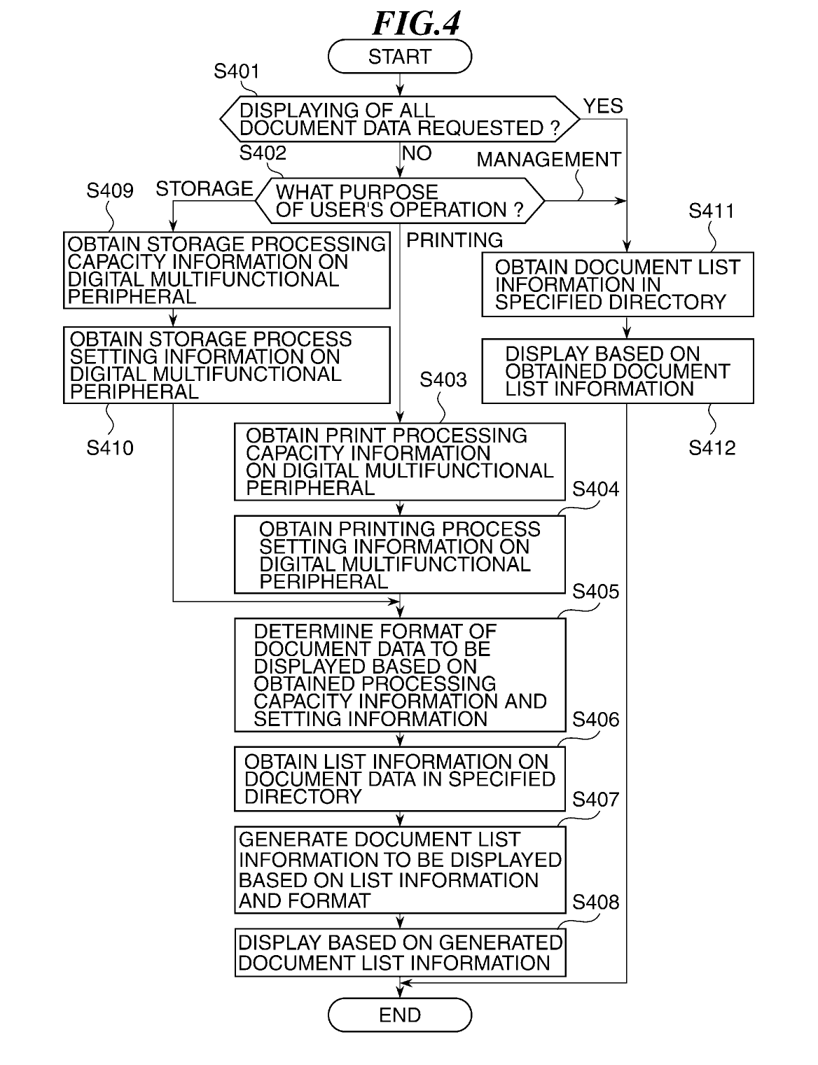

FIG. 4 is a flowchart showing a process carried out by the digital multifunctional peripheral 110 according to the first embodiment of the present invention when displaying of a document data list is requested. This process is carried out when an instruction to display a list of document data stored in a specified directory in a box is given by the user via the console 230, and the processing request receiving unit 311 receives a document data list obtaining request. It should be noted that this process is executed by the software that carries out the above described processes on document data.

In step S401, it is determined whether or not the document data list obtaining request received by the processing request receiving unit 311 from the console 230 is to display all document data stored in the specified directory or to display only necessary document data. When it is determined that the document data list acquisition request received from the console 230 is not to display all document data, the process proceeds to step S402. On the other hand, when it is determined that the document data list obtaining request received from the console 230 is to display all document data, the process proceeds to step S411.

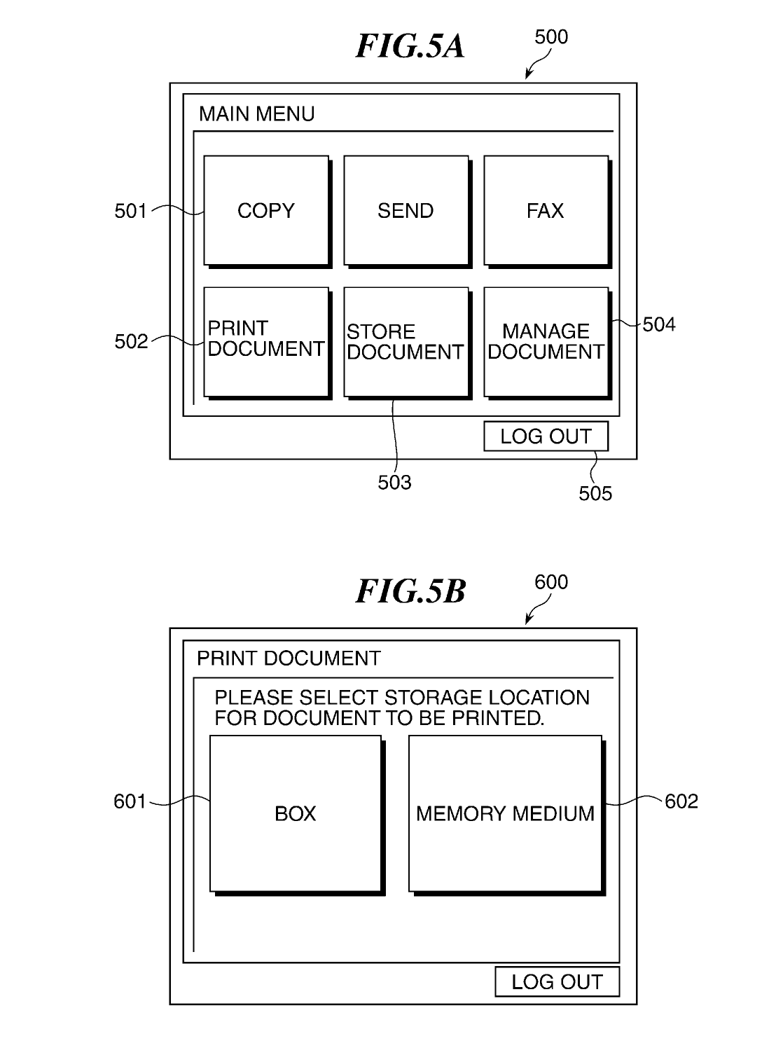

In the step S402, the purpose of a user's operation is determined based on the content of the document data list obtaining request received by the processing request receiving unit 311. In the present embodiment, it is determined whether the purpose of the user's operation of attempting to display document data in the specified directory is printing, storage, or management. In the present embodiment, the determination as to the purpose of the user's operation is made by determining which button is depressed by the user on a screen displayed on the console 230 (a screen in FIG. 5A described later). For example, when a “document storage button 503” is depressed, the purpose of the user's operation is storage, and when a “document printing button 502” is depressed, the purpose of the user's operation is printing.

First, a description will be given of a process carried out when it is determined in the step S402 that the purpose of the user's operation is printing. When it is determined that the purpose of the user's operation is printing, the process proceeds to step S403.

In the step S403, the processing capacity determination unit 313 obtains information on a print processing capacity of the digital multifunctional peripheral 110 according to the result of the determination in the step S402. Here, the print processing capacity of the digital multifunctional peripheral 110 means a capacity indicative of whether or not the controller unit 200 or the printer unit 250 is able to carry out print processing on document data in a predetermined format. Specifically, the print processing capacity of the digital multifunctional peripheral 110 means a processing capacity indicative of, for example, which format can be processed by the RIP 212 and printed by the printer unit 250.

Next, in step S404, the processing capacity determination unit 313 obtains print setting information on the digital multifunctional peripheral 110 according to the result of the determination in the step S402. Here, the print setting information is information on option settings, settings configured by an administrator, and settings for print processing executable by user's processing authority. Examples of the print setting information include information that the digital multifunctional peripheral 110 has a processing capacity to print a JPEG file, but a function of printing a JPEG file is disabled by some administrator. Examples of the print setting information also include information that a JPEG file can be printed by authority of an operating user, but printing of a PDF file is not permitted. Examples of the print setting information further include information that all the options required to print a PDF file are not enabled.

Next, in step S405, the processing capacity determination unit 313 determines a format (document type) of document data to be displayed on the console 230 based on the information obtained in the step S403 and the step S404. After that, the control unit 312 causes the document data input-output unit 314 to carry out a document data list obtaining process. Specifically, in step S406, the document data input-output unit 314 obtains document list information on the document data in the specified directory from the document data management unit 320.

Next, in step S407, the document data input-output unit 314 generates document list information to be displayed on the console 230 based on the document list information obtained in the step S406 and the format determined in the step S405. In step S408, the control unit 312 produces a screen display on the console 230 based on the document list information generated by the document data input-output unit 314, followed by terminating the process.

Next, a description will be given of a screen displayed on the console 230 in the above described process carried out in the case where the purpose of the user's operation is printing.

FIG. 5A shows an exemplary main menu screen 500 displayed on the console 230 of the digital multifunctional peripheral 110. The main menu screen 500 is a screen for displaying functions of the digital multifunctional peripheral 110 available for use by a user who has logged in. Although in the example shown in FIG. 5A, a copy button 501, the document printing button 502, the document storage button 503, a document management button 504, and so on are disposed, the present invention is not limited to this, but different types of buttons may be displayed for different users. A user who operates the digital multifunctional peripheral 110 selects any of these buttons according to a process which he/she intends to carry out. When a logout button 505 is depressed, logging-out of the user is carried out.

When the user depresses the document printing button 502, a storage location selection screen 600 as shown in FIG. 5B is displayed. The user selectively determines on the storage location selection screen 600 whether to print document data stored in a box or print document data in a memory medium device connected to the digital multifunctional peripheral 110. It should be noted that, when it is possible to print document data from an external file server, a button for selecting a file server is displayed on the storage location selection screen 600, although this is not shown.

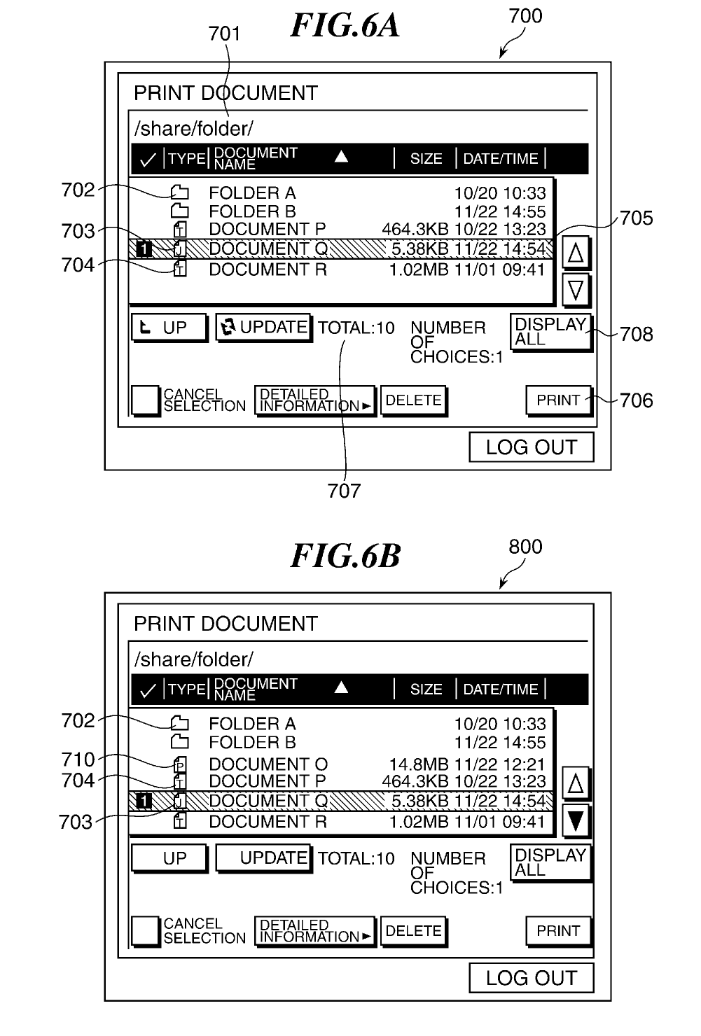

When the user depresses a box selection button 601 to give an instruction to print document data stored in a box, a document list screen 700 as shown in FIG. 6A is displayed. When the document list screen 700 is to be displayed, the above described processes in the steps S401 to S408 in FIG. 4 are carried out to generate document list information to be displayed on the document list screen 700.

On the document list screen 700 are displayed directory information 701 indicative of information of a directory being displayed, type marks 702 to 704 indicative of data types, and document data information (for example, document name, size, and date and time of creation). The user depresses a row in which document data which he/she intends to print is displayed, thus bringing the row into a selected state 705, and then depresses a printing instruction button 706 to given and instruction to carry out printing.

On the document list screen 700, only document data in TIFF and JPEG formats which is document data in printable formats is displayed. On this occasion, a total number of directories and document data actually stored in this directory is displayed as an in-directory item count 707. Thus, the user can recognize that the information being displayed is only document data and directories that can be operated, and a total of 10 directories and document data are actually stored. If the user intends to obtain all document data in this directory, he/she can display all document data by selecting a display switch button 708 and switching displayed contents of the document list.

Referring to FIG. 4, a description will be given of a process carried out when the display switch button 708 is selected, and a request to display all document data is received.

When it is determined in the step S401 that the request is to display all document data, the process proceeds to the step S411. In the step S411, the control unit 312 requests the document data input-output unit 314 to obtain all document data. Then, the document data input-output unit 314 obtains all document data in the target directory from the document data management unit 320, and sends back document data information to the control unit 312. Then, in step S412, document data list information is generated using the document data information sent back from the document data input-output unit 314, and the generated document data list information is sent back to the request source, followed by termination of the process. FIG. 6B shows an exemplary document list screen displayed as a result of the above process. Although on the document list screen 700 in FIG. 6A, only document data in printable TIFF and JPEG formats is displayed, document data 710 in unprintable PDF format is also displayed on a document list screen 800 in FIG. 6B.

Next, a description will be given of a process carried out when it is determined in the step S402 in FIG. 4 that the purpose of the user's operation is storage.

When it is determined in the step S402 that the purpose of the user's operation is storage, the process proceeds to step S409. In the step S409, the processing capacity determination unit 313 obtains information on a storage processing capacity of the digital multifunctional peripheral 110 according to the result of the determination in the step S402. Here, the storage processing capacity of the digital multifunctional peripheral 110 means a capacity to carry out a process executable in relation to conversion into formats by the controller unit 250 and the scanner unit 240. Specifically, the storage processing capacity of the digital multifunctional peripheral 110 means a processing capacity indicative of, for example, a format into which data scanned in by the scanner unit 240 can be converted.

Next, in step S410, the processing capacity determination unit 313 obtains storage processing setting information on the digital multifunctional peripheral 110 according to the result of the determination in the step S402. Here, the storage processing setting information is information on option settings, settings configured by an administrator, and settings for storage processing executable by user's processing authority. Examples of the storage processing setting information include information that the digital multifunctional peripheral 110 has a processing capacity to covert scanned-in image data into a PDF file and store the same, but a function of storing the image data in a PDF file is disabled by some administrator. Examples of the storage processing setting information also include information that a JPEG file can be stored by authority of an operating user, but storage in a PDF file is not permitted. Examples of the print setting information further include information that all the options required to covert scanned-in image data into a PDF file and store the same are not enabled.

Next, in the step S405, the processing capacity determination unit 313 determines a format (document type) of document data to be displayed on the console 230 based on the information obtained in the step S409 and the step S410. After that, in the steps S406 to S408, the same processes as the above described processes carried out in the case where the purpose is printing are carried out, followed by termination of the process.

Next, a description will be given of a screen displayed on the console 230 in the above described process in the case where the purpose of the user's operation is storage.

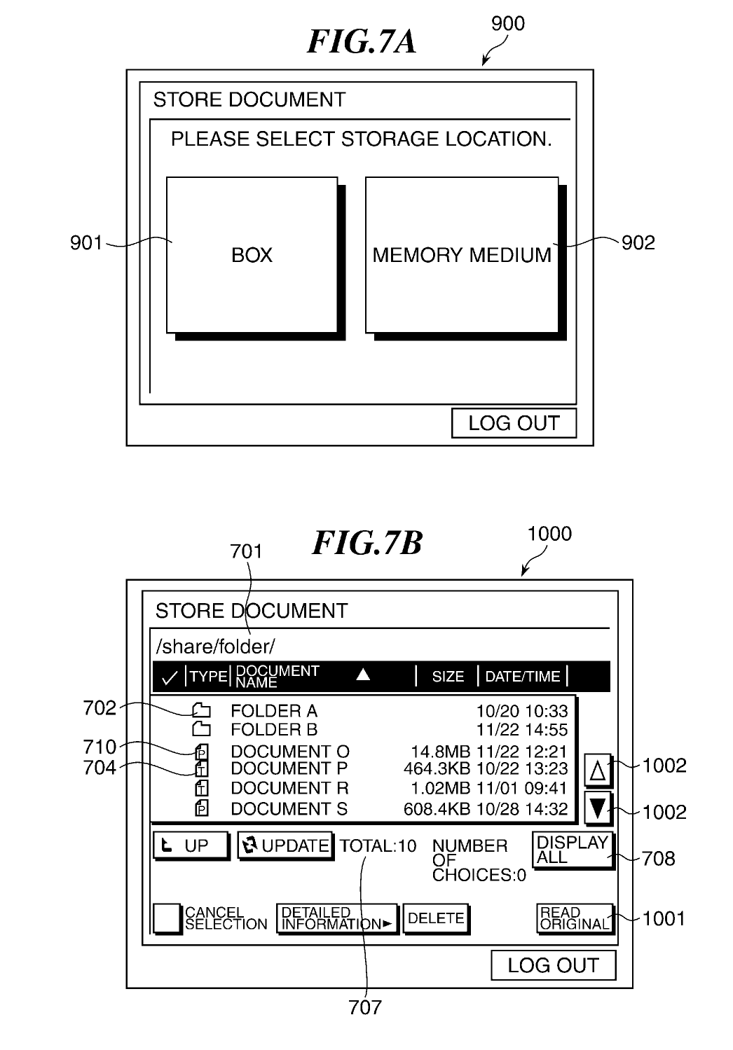

When the user depresses the document storage button 503 on the main menu screen 500, a storage location selection screen 900 as shown in FIG. 7A is displayed. When a box selection button 901 is depressed similarly to the case where the purpose of the user's operation is printing, a document list screen 1000 as shown in FIG. 7B is displayed. When the document list screen 1000 is to be displayed, the processes in the steps S401 to S402, S409, S410, and S405 to S408 in FIG. 4 are carried out to generate document list information to be displayed on the document list screen 1000.

In a document list on the document list screen 1000 in FIG. 7B, a PDF file (document data 710) that is not displayed in the document list on the document list screen 700 in FIG. 6A is displayed. On the other hand, a JPEG file (type mark 703) that is displayed in the document list on the document list screen 700 is not displayed in the document list on the document list screen 1000. This is because it is determined that formats of document data that can be converted by the digital multifunctional peripheral 110 are PDF and TIFF, and the document list is generated.

Similarly to the case where the purpose of the user's operation is printing, the user can know the presence of other document data stored in the directory by referring to an in-directory item count 707. By depressing a display switch button 708, the user may display all document data on the document list screen.

Next, a description will be given of a process carried out when it is determined in the step S402 in FIG. 4 that the purpose of the user's operation is management.

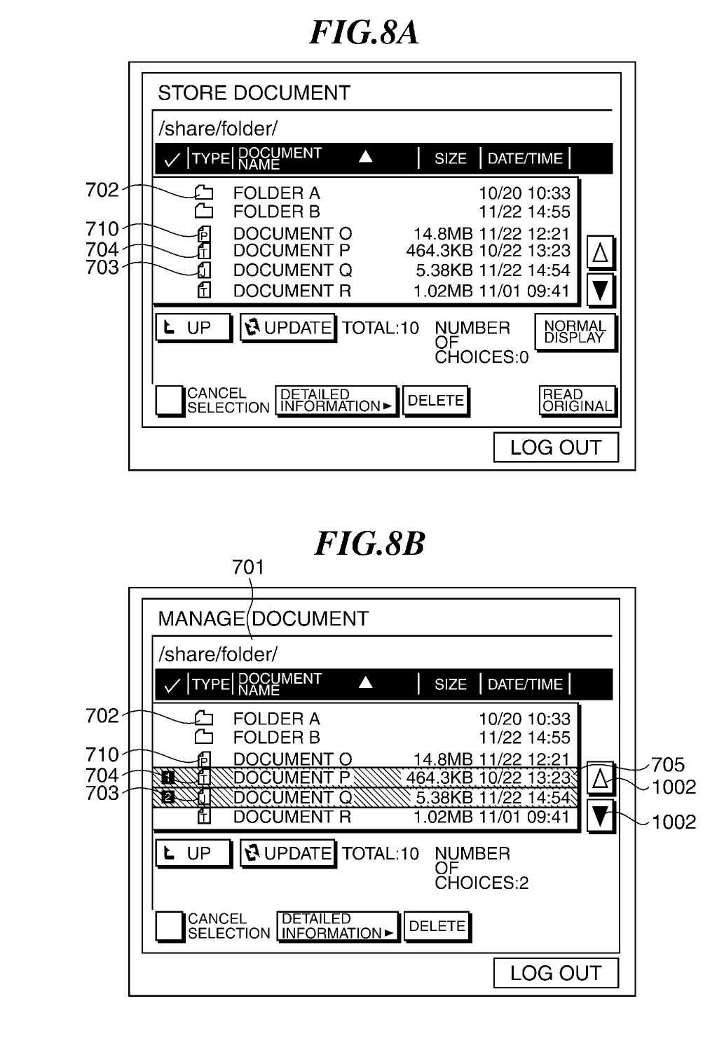

When the document management button 504 is depressed on the main menu screen 500, it is determined in the step S402 that the purpose of the user's operation is management, and the process proceeds to the step S411. In the present embodiment, because all document data is displayed in the case where the purpose of the user's operation is management, a process to obtain all document data is carried out (the steps S411 and S412), and a document list screen is displayed similarly to the case where the display switch button 708 is depressed. FIG. 8B shows a document list screen displayed in the case where the purpose is management.

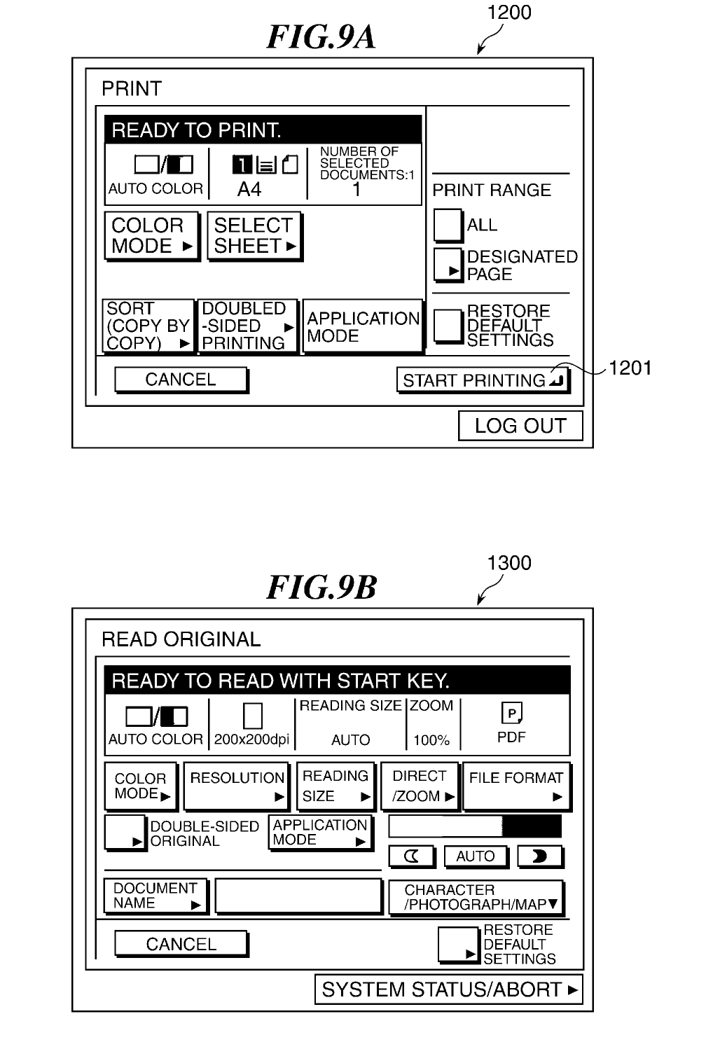

When the user performs operation in the box for the purpose of printing, the document list screen 700 as shown in FIG. 6A is displayed. On the document list screen 700, only printable document data is displayed, and hence selection of incorrect data can be prevented. The user displays a print setting screen 1200 shown in FIG. 9A by selecting printable document data being displayed and depressing the printing instruction button 706. After that, when a printing start button 1201 on the printing setting screen 1200 is depressed, the digital multifunctional peripheral 110 starts carrying out a printing process.

Also, when the user performs operation in the box for the purpose of storage, the document list screen 1000 as shown in FIG. 7B is displayed. On the document list screen 1000, only document data that can be stored is displayed, and hence this is user-friendly, so that overlapping document data names can be prevented from being set by mistake. Moreover, the user can be prevented from erroneously assuming that document data can be stored in JPEG format. Further, when an original reading instruction button 1001 is depressed, an original reading screen 1300 as shown in FIG. 9B is displayed so that the user can set a file format, a document name, and so on and give an instruction to carry out a storage process.

Further, when the user wants to view all document data although the purpose of the user's operation is management, printing, or storage, all document data can be displayed according to an instruction from the user. Namely, because all document data can be displayed when the user intends to view all document data, a display intended by the user can be produced. It should be noted that in the case where all document data is displayed as shown in FIG. 6B and FIG. 8A, when document data is in format that cannot be printed (or stored), this is indicated as such when the document data is displayed. For example, the document data may be grayed out. Then, the document data may be merely displayed and inhibited from being selected by the user. With this arrangement, even when all document data is displayed, for example, the user can be prevented from give an instruction to print document data in an unprintable format.

In the document data list display in FIG. 6A and the like, a display indicative of a data format (for example, JPEG format, TIFF format, or PDF format) may be produced with respect to each document data. It should be noted that “P”, “T”, and “J” displayed in icons of “Type” on the document list screen in FIGS. 6A, 6B, 7B, 8A, and 8B indicate whether a format of document data is PDF, TIFF, or JPEG.

As described above, in the digital multifunctional peripheral 110, it is determined, for example, whether a user's operation is printing or storage based on a user's instruction and request, and processing capacity information and setting information on the digital multifunctional peripheral 110 which suit the determined purpose are obtained. Then, based on the obtained processing capacity information and setting information, a format of document data to be displayed is determined. Further, display information to be displayed on a document list screen is generated based on document list information on document data which complies with the user's instruction and request, and the determined format of document data. As a result, a suitable display can be produced according to the user's operation purpose, and this enhances operability for the user.

In a second embodiment of the present invention, an arrangement shown in FIGS. 1 to 3 is the same as that in the first embodiment described above, and elements and parts that are the same as those in the first embodiment will thus be designated by the same reference numerals and not be described, only features that are different from those of the first embodiment being described below.

As for the second embodiment of the present invention, a description will be given of a process carried out by the digital multifunctional peripheral 110 when a box (document data storage region) in the digital multifunctional peripheral 110 is accessed from the computer 120 via the network 100. It should be noted that document data in the box and a processing capacity of the digital multifunctional peripheral 110 are the same as those in the first embodiment described above.

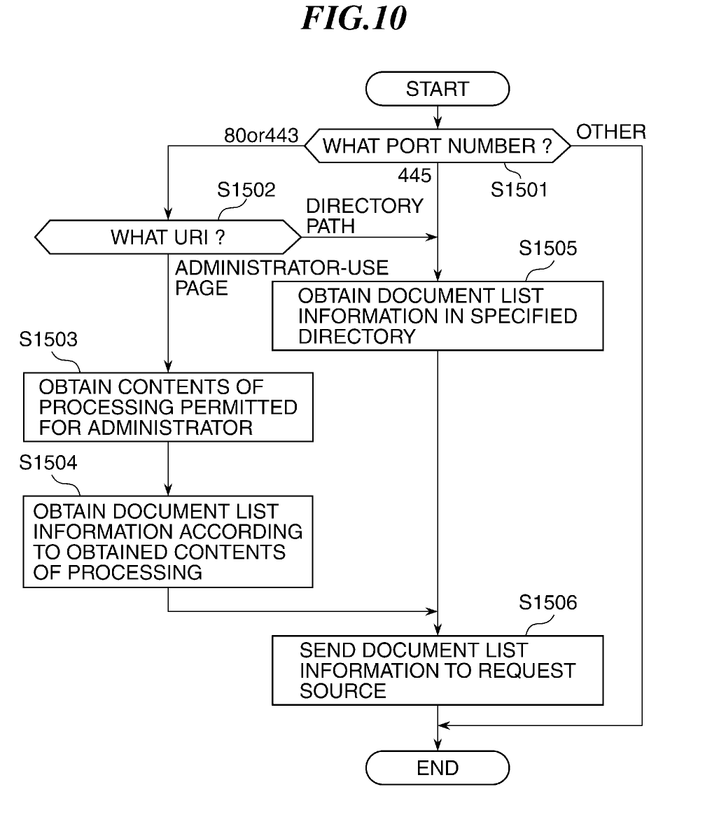

FIG. 10 is a flowchart showing a process carried out by the digital multifunctional peripheral 110 according to the second embodiment of the present invention upon receipt of a document data list displaying request.

Upon receiving request information, a request from the computer 120, via the network I/F 209 in the digital multifunctional peripheral 110, the processing request receiving unit 311 determines a port number during the receipt of the request information (step S1501). When the port number is 80 or 443, the process proceeds to step S1502, and on the other hand, when the port number is 445, the process proceeds to step S1505. In other cases, the process is terminated with nothing being done.

In the step S1502, the control unit 312 analyzes the received request information, and obtains information on a URI from the request information to determine whether the URI is an address to a directory path or an address of an administrator-use page. When it is determined that the URI is an address of an administrator-use page, the process proceeds to step S1503, and on the other hand, when it is determined that the URI is an address to a directory path, the process proceeds to the step S1505.

In the step S1503, the processing capacity determination unit 313 obtains contents of processing permitted for an administrator, and determines whether or not directory information can be displayed and whether or not document data information can be displayed. In the present embodiment, it is assumed that an administrator is permitted to display only directory information.

Then, in step S1504, the control unit 312 generates document list information according to the contents of processing obtained in the step S1503. In the present embodiment, the control unit 312 obtains directory information to be displayed on the administrator-use page via the document data input-output unit 314. Here, only the directory information is obtained, and document data information is not obtained. The control unit 312 generates document list information by combining the obtained information and information on the administrator-use page obtained from the address of the administrator-use page. Then, in step S1506, the control unit 312 sends the generated document list information to the computer 120 as the request source.

On the other hand, in the step S1505, the control unit 312 determines to obtain information in a specified directory irrespective of the processing capacity of the digital multifunctional peripheral 110, and obtains document list information in the specified directory via the document data input-output unit 314. Then, in the step S1506, the control unit 312 sends the obtained document list information to the computer 120 as the request source.

On the other hand, when it is determined in the step S1501, that the port number is 445, the process proceeds to the step S1505 in which the control unit 312 obtains document list information in the specified directory via the document data input-output unit 314. Then, in the step S1506, the control unit 312 sends the obtained document list information to the computer 120 as the request source.

Next, a description will be given of an exemplary screen displayed on the computer 120 in the above described process.

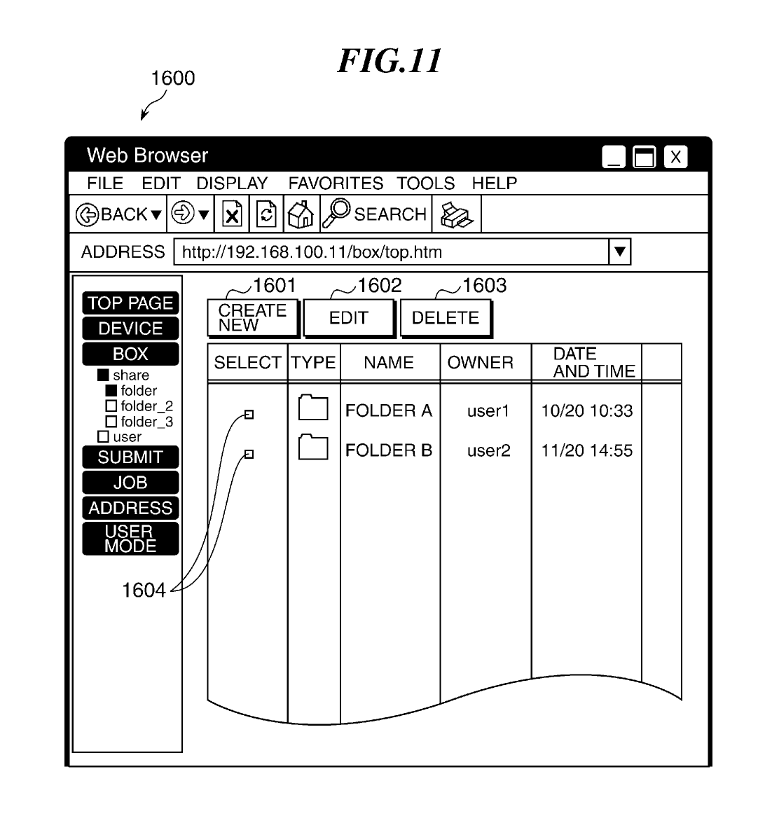

FIG. 11 is a view showing an exemplary screen displayed on the administrator-use page in a case where the administrator-use page is accessed via a Web browser operating on the computer 120 to display data under a/share/folder/directory.

Because an administrator is permitted to view/operate only directory information, for example, only a folder A and a folder B are displayed on an illustrated display screen 1600 on the administrator-use page. On the display screen 1600 on the administrator-use page are disposed a new document button 1601 for requesting creation of a new directory, an edit button 1602 for requesting edition of a directory, and a delete button 1603 for requesting deletion of a directory. Further, on the display screen 1600 on the administrator-use page are disposed checkboxes 1604 for designating directories targeted for operation. On the display screen 1600 on the administrator-use page, document data information on which operation cannot be performed is not displayed, and only information on directories on which operation can be performed is displayed. Thus, only information necessary for an administrator is displayed, which is user-friendly.

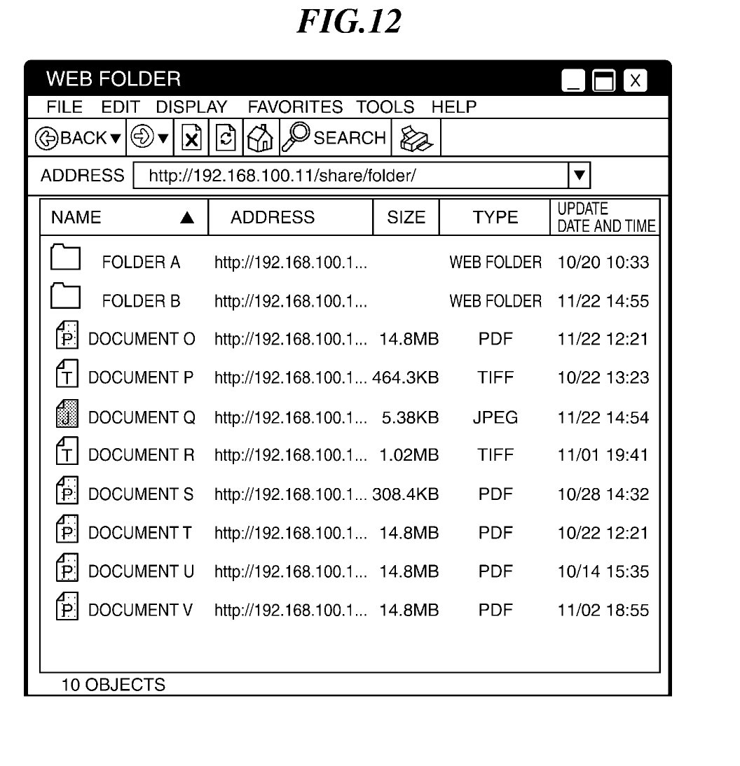

FIG. 12 is a view showing an exemplary screen displayed in a case where a URI to a directory path is accessed via the Web browser to display data under the share/folder/directory.

The screen shown in FIG. 12 is displayed in the processes in the steps S1505 and S1506 after it is determined in the step S1502 in FIG. 10 that the URI is an address to a directory path. On the screen shown in FIG. 12, all document data information under the share/folder/directory is displayed as distinct from the case of the administrator-use page.

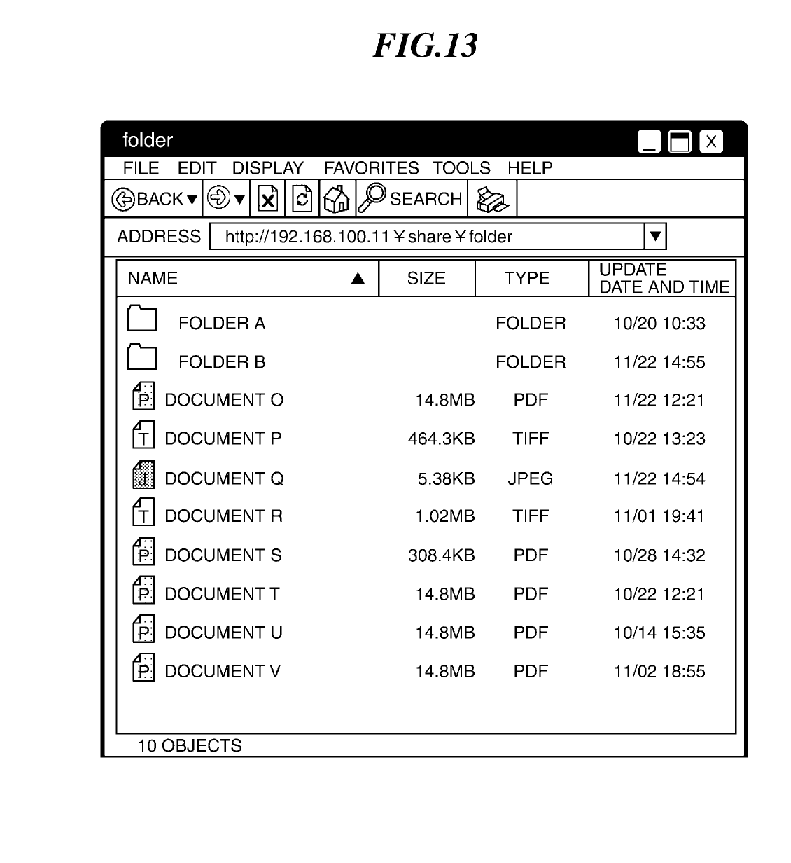

FIG. 13 is a view showing an exemplary screen displayed in a case where access is made from the computer 120 using a client application according to CIFS protocol, not via the Web browser.

The screen shown in FIG. 13 is displayed in the processes in the steps S1505 and S1506 after it is determined in the step S1501 in FIG. 10 that the port number is 445. On the screen shown in FIG. 13, all document data information under the share/folder/directory is displayed similarly to the screen shown in FIG. 12.

According to the second embodiment, when a box in the digital multifunctional peripheral 110 is accessed from the computer 120, a purpose of the user's access is determined based on a protocol, port number, and URI in an access. Then, a displaying capacity is determined based on the purpose and contents of the access, so that by changing contents to be displayed even when access is made from the same computer 120, necessary and adequate information can be appropriately provided to the user.

In a third embodiment of the present invention, an arrangement shown in FIGS. 1 to 3 is the same as that in the first embodiment described above, and parts and elements that are the same as those in the first embodiment will thus be designated by the same reference numerals and not be described, only features that are different from those of the first embodiment being described below.

As for the third embodiment of the present invention, a description will be given of a process carried out by the digital multifunctional peripheral 110 when storage in a box (document data storage region) in the digital multifunctional peripheral 110 is requested from the computer 120 via the network 100. It should be noted that document data in the box and a processing capacity of the digital multifunctional peripheral 110 are the same as those in the first and second embodiments described above.

As distinct from the first and second embodiments described above, the third embodiment relates to a determination method for use in storing document data, not a method of displaying document list information. As described above in the second embodiment, the user accesses the box region in the digital multifunctional peripheral 110 from the computer 120 using a Web browser or a client application according to CIFS/SMB protocol. A description will be given of a process carried out by the digital multifunctional peripheral 110 when in the above case, storage of any given document data in the box region in the digital multifunctional peripheral 110 is requested from the computer 120.

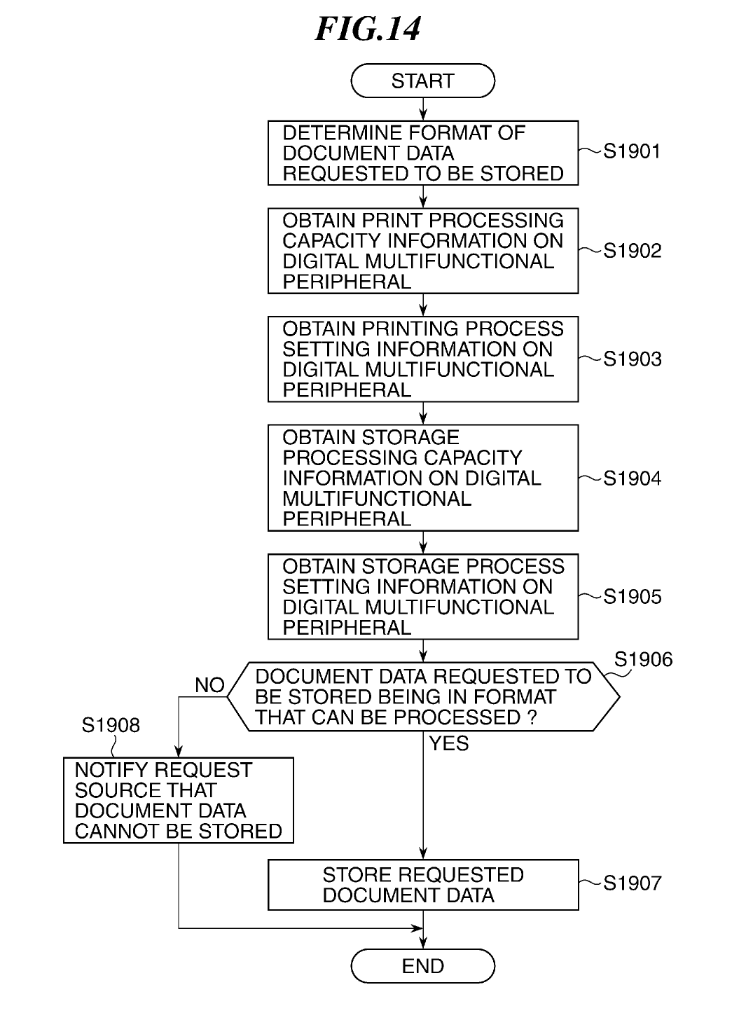

FIG. 14 is a flowchart showing the process carried out by the digital multifunctional peripheral 110 when storage of document data is requested in the third embodiment of the present invention.

First, when it is determined that the processing request receiving unit 311 has received a storage request, the control unit 312 determines, in step S1901, a format of document data requested to be stored. The determination may be made, for example, based on an extension of the document data, and by analyzing header information of the document data.

Next, in steps S1902 to S1905, the processing capacity determination unit 313 obtains print processing capacity information, print setting information, storage processing capacity information, and storage process setting information on the digital multifunctional peripheral 110. These processes are the same as those in the steps S403, S404, S409, and S410 in FIG. 4 described above in the first embodiment, and therefore description thereof is omitted.

In step S1906, the control unit 312 determines whether or not the format of the document data determined in the step S1901 is a format that can be processed by the digital multifunctional peripheral 110 based on the information obtained in the steps S1902 to S1905. When determining that the format of the document data can be processed, the control unit 312 causes the document data input-output unit 314 to store the requested document data in the document data management unit 320 (step S1907), followed by terminating the process.

On the other hand, when determining that the format of the document data cannot be processed, the control unit 312 sends display information to the effect that the storage request cannot be accepted to the request source, followed by terminating the process.

Although in the present embodiment, information on both the print processing capacity and the storage processing capacity of the digital multifunctional peripheral 110 are obtained as information on the processing capacity of the digital multifunctional peripheral 110, and it is determined whether or not document data requested to be stored can be stored, the determination may be made based on only the print processing capacity or only the storage processing capacity.

As described above, even in a case where a storage region in the digital multifunctional peripheral is made operable from a computer, data that cannot be processed by the digital multifunctional peripheral can be prevented from being stored from an external device. This can prevent processing when a user has made an erroneous operation, and prevent a storage region in the digital multifunctional peripheral from becoming full with unnecessary data.

Although in the above described embodiments, the present invention is applied to the image forming apparatus, the present invention is not limited to this, but the present invention may be applied to an information processing apparatus and an image processing apparatus such as a computer, and it goes without saying that the effects of the present invention can be obtained by applying the present invention to a processing apparatus including them.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-140020 filed Jun. 11, 2009, which is hereby incorporated by reference herein in its entirety.

What is claimed is:

1. A processing apparatus that generates display information in response to a processing request from a user for document information, comprising:
a first determination unit adapted to determine a purpose of the user's operation;
an obtaining unit adapted to obtain processing capacity information on the processing apparatus, which suits the determined purpose;
a second determination unit adapted to, based on the obtained processing capacity information, determine a type of document information to be displayed; and
a generation unit adapted to generate the display information in accordance with document information corresponding to the type determined by said second determination unit.

2. A processing apparatus as claimed in claim 1, wherein said obtaining unit obtains at least formats of document information that can be printed or formats of document information that can be converted as the processing capacity information on the processing apparatus.

3. A processing apparatus as claimed in claim 1, wherein said obtaining unit obtains setting information on the processing apparatus, and said second determination unit determines a type of document information to be displayed based on the obtained processing capacity information and setting information.

4. A processing apparatus as claimed in claim 1, wherein said obtaining unit obtains at least setting information on document information in formats that can be printed or setting information on document information in formats that can be converted as setting information on the processing apparatus.

5. A processing apparatus as claimed in claim 1, wherein said first determination unit determines whether a purpose of the user's operation is to carry out a document printing process using the processing apparatus or to carry out a document storage process using the processing apparatus.

6. A processing apparatus that is connected to an information processing apparatus via a network, and carries out a storage process in response to a request for document information from the information processing apparatus, comprising:
a determination unit adapted to determine a port number of a port having received the request;
an obtaining unit adapted to obtain display information in response to the request for document information according to the determined port number; and
a sending unit adapted to send the obtained display information to the information processing apparatus as a request source.

7. A processing method for a processing apparatus that generates display information in response to a processing request from a user for document information, comprising:
a first determination step of determining a purpose of the user's operation;
an obtaining step of obtaining processing capacity information on the processing apparatus, which suits the determined purpose;
a second determination step of, based on the obtained processing capacity information, determining a type of document information to be displayed; and
a generation step of generating the display information in accordance with document information corresponding to the type determined in said second determination step.

8. A processing method for a processing apparatus that is connected to an information processing apparatus via a network, and carries out a storage process in response to a request for document information from the information processing apparatus, comprising:
a determination step of determining a port number of a port having received the request;
an obtaining step of obtaining display information in response to the request for document information according to the determined port number; and
a sending step of sending the obtained display information to the information processing apparatus as a request source.

9. A non-transitory storage medium storing a computer-readable program for causing a computer to execute a processing method as claimed in claim 7.

10. A non-transitory storage medium storing a computer-readable program for causing a computer to execute a processing method as claimed in claim 8.
